(19) United States
(12) Patent Application Publication
(10) Pub. No.: US 2009/0018976 A1
(43) Pub. Date: Jan. 15, 2009

(54) Method and system for providing price quotes for new and used vehicles

(76) Inventors: David W. Paulovich, Midland, PA (US); Joseph M. Staffilino, SR., Steubenville, OH (US)

Correspondence Address: Hoffman, Wasson & Gitler, P.C., Suite 522, 2461 South Clark Street, Arlington, VA, 22202, US

(21) Appl. No.: 12/216,931

(22) Filed: Jul. 14, 2008

Related U.S. Application Data
(60) Provisional application No. 60/929,826, filed on Jul. 13, 2007.

(51) Int. Cl. G06Q 99/00

(52) U.S. Cl. 705/400

(57) ABSTRACT

The system provides the user with all relevant information, allowing the information to be tailored from the dealership for which the consumer will purchase the vehicle. The process is completely automated, allowing for users to instantaneously receive pricing information on the new vehicle of their choice as well as their trade-in, not having to wait for a reply from a salesperson in a dealership. The user provides information regarding the new vehicle desired and the trade-in vehicle and the user's zip code. The zip code provided is used to identify the dealership that has been assigned to that area of responsibility, as well as for the calculation of the price since factory incentives often vary according to geographical area. And, the dealership's distance from the zip code can be used as a factor in determining the provided pricing information.

This application claims benefit of provisional application 60/929,826, filed Jul. 13, 2007.

### BACKGROUND OF THE INVENTION

The internet has become a popular outlet for consumers to gather information regarding a product, particularly price. This is true of all products, large or small, as several web sites provide pricing for large items such as automobiles. Often, these web sites are hosted by a particular dealership advertising their inventory.

When purchasing a new vehicle, the buyer often wishes to trade in their current vehicle. It is common to trade in the vehicle to the dealership where the new car is being purchased. The price obtained for the trade-in vehicle is a large factor in determining where to buy the new car.

Consumers need a “one stop shopping” website to gather all information needed to make an informed choice when purchasing a car as well as when trading in their existing car.

It is an object of the invention to provide a single source for consumer information, to complete a vehicle pricing transaction instantly, and anonymously, 24 hours a day, without third party contact until the shopper chooses to initiate it.

It is another object of the invention to provide information on both new and trade-in vehicle costs, allowing the shopper to build his or her new vehicle of choice option by option, as well as securing a trade-in value.

It is yet another object of the invention to have an automated system for providing pricing information for both new and trade-in vehicles without the need to have a salesman's input.

These and other objects of the invention will be apparent to one of ordinary skill in the art after reading the disclosure of the invention.

### SUMMARY OF THE INVENTION

The system provides the user with all relevant information, allowing the information to be tailored from the dealership for which the consumer will purchase the vehicle. The process is completely automated, allowing for users to instantaneously receive pricing information on the new vehicle of their choice as well as their trade-in, not having to wait for a reply from a salesperson in a dealership. The user provides information regarding the new vehicle desired and the trade-in vehicle and the user's zip code. The zip code provided is used to identify the dealership that has been assigned to that area of responsibility, as well as for the calculation of the price since factory incentives often vary according to geographical area. And, the dealership's distance from the zip code can be used as a factor in determining the provided pricing information. Also, participating dealerships will be able to adjust their prices according to distance halos which will be identified by preselected zip codes. The price for the new vehicle and the trade-in is shown while the user has only provided a zip code to identify his or her geographical area. No other personal information is required unless the user is interested in complete detail on the quote.

### DETAILED DESCRIPTION OF THE INVENTION

The system uses a network of dealerships for every make, model and geographical area possible. A user enters the make, model and options in a new car, and the make and model of the trade-in vehicle, along with mileage and estimate of the general condition of the vehicle, including damage. The user also enters a zip code. Entering the zip code matches the request with current factory incentives and the dealers for that vehicle in that area. If no dealer for that particular make is available, the system can provide alternative vehicles and the user can choose from a dealer for those vehicles in that area.

From the database, the system retrieves the price of the new vehicle from the dealership associated with the user's zip code. Likewise, the system retrieves the trade-in value for the user's vehicle, as provided by the dealerships. This pricing information is stored in the database and can be retrieved at anytime without the need for the involvement of anyone associated with a dealership.

The starting point for the trade-in value is obtained from any one of the well known databases of used car values, such as Kelley Blue Book. The value of the trade-in vehicle can be adjusted based on the particular dealership. For instance, a particular dealership may offer a flat 10% increase in the used vehicle value. Also, the dealership may, for a limited time or always, offer a premium for certain makes and models. If a dealership finds that certain makes and models have greater value as the trade-in, the dealer may be willing to offer such a premium.

Also, the cost of the new car and value of the trade-in may be adjusted based on the dealership's distance from the user's zip code. For a zip code further from the dealership, the dealer can offer a lower price on the new vehicle or a higher trade-in allowance as an inducement for the user to travel to a dealership which may not be the closest dealer for that make and model. A dealership may also use distance “halos”, with each larger halo, being a greater distance from the dealership, offering a greater inducement to the user. As all calculations are performed automatically by the system, the user is able to obtain the cost of the new vehicle and the trade-in allowance instantaneously. Therefore, the user may obtain this information at any time of day or night. The values obtained are customized by each dealership based on the criteria of the user's zip code and adjustments to the database of new and used car values, as described above. The system totally eliminates the need for salesman interaction until the potential customer indicates interest in the quote. The system provides a net price without requiring any of the user's personal information other than a zip code.

While the invention has been described with reference to a preferred embodiment, variations and modifications would be apparent to one of ordinary skill in the art without departing from the scope of the invention. The invention encompasses such variations and modification.

We claim:

1. A method for conducting vehicle transactions comprising
maintaining a database having information for a plurality of vehicle dealerships,
inputting a zip code and a new vehicle of choice, make, model, trim and options by a user,
inputting a trade-in vehicle make, model, options, mileage and damage description by a user,
providing a price for the new vehicle and trade-in value for each dealership within a preselected distance from the zip code,
calculating a net price for each dealership, and
providing the net price to the user.

2. The method of claim 1, wherein
the net price is adjusted based on a dealership's distance from the zip code.

3. The method of claim, 1, wherein
the trade-in value is adjusted from a standard value for each dealership.

4. The method of claim 1, further comprising
providing information for another make and model vehicle if the user's vehicle is not available within a preselected distance from the zip code.
